(19) United States
(12) Patent Application Publication
(10) Pub. No.: US 2006/0057055 A1
(43) Pub. Date: Mar. 16, 2006

(54) Rhenium catalysts and methods for production of single-walled carbon nanotubes

(76) Inventors: Daniel E. Resasco, Norman, OK (US); Pisan Chungchamroenkit, Pomprab (TH); Jose Effrain Herrera, Norman, OK (US); Leandro Balzano, Norman, OK (US)

Correspondence Address: DUNLAP, CODDING & ROGERS P.C., PO BOX 16370, OKLAHOMA CITY, OK, 73113, US

(21) Appl. No.: 11/000,283

(22) Filed: Nov. 30, 2004

Related U.S. Application Data
(60) Provisional application No. 60/529,665, filed on Dec. 15, 2003.

(51) Int. Cl. D01F 9/12; B01J 21/18

(52) U.S. Cl. 423/447.3; 502/185

(57) ABSTRACT

The present invention is a method and catalyst for selectively producing single-walled carbon nanotubes. The catalyst comprises rhenium and a Group VIII transition metal, for example Co, which is preferably disposed on a support material to form a catalytic substrate. In the method, a carbon-containing gas is exposed to the catalytic substrate at suitable reaction conditions whereby a high percentage of the carbon nanotubes produced by the reaction is single-walled carbon nanotubes.

### CROSS-REFERENCE TO RELATED APPLICATIONS

This application claims the benefit under 35 U.S.C. 119(e) of U.S. Provisional Application Ser. No. 60/529,665, filed Dec. 15, 2003, the contents of which are hereby expressly incorporated by reference herein in its entirety.

### STATEMENT REGARDING FEDERALLY SPONSORED RESEARCH OR DEVELOPMENT

Not applicable.

### BACKGROUND OF THE INVENTION

This invention is related to the field of catalysts for producing carbon nanotubes and methods of their use, and more particularly, but not by way of limitation, single-walled carbon nanotubes, and to composites and products comprising single-walled carbon nanotubes.

Carbon nanotubes (also referred to as carbon fibrils) are seamless tubes of graphite sheets with full fullerene caps which were first discovered as multi-layer concentric tubes or multi-walled carbon nanotubes and subsequently as single-walled carbon nanotubes in the presence of transition metal catalysts. Carbon nanotubes have shown promising applications including nanoscale electronic devices, high strength materials, electron field emission, tips for scanning probe microscopy, and gas storage.

Generally, single-walled carbon nanotubes are preferred over multi-walled carbon nanotubes for use in these applications because they have fewer defects and are therefore stronger and more conductive than multi-walled carbon nanotubes of similar diameter. Defects are less likely to occur in single-walled carbon nanotubes than in multi-walled carbon nanotubes because multi-walled carbon nanotubes can survive occasional defects by forming bridges between unsaturated carbon valances, while single-walled carbon nanotubes have no neighboring walls to compensate for defects.

Single-walled carbon nanotubes exhibit exceptional chemical and physical properties that have opened a vast number of potential applications.

However, the availability of these new single-walled carbon nanotubes in quantities and forms necessary for practical applications is still problematic. Large scale processes for the production of high quality single-walled carbon nanotubes are still needed, and suitable forms of the single-walled carbon nanotubes for application to various technologies are still needed. It is to satisfying these needs that the present invention is directed.

A number of researchers have investigated different catalyst formulations and operating conditions for producing carbon nanotubes. Yet obtaining high quality SWNT has not been always possible with this method. Among the various catalyst formulations previously investigated, Co—Mo catalysts supported on silica gel which had low Co:Mo ratios exhibited the best performance.

In previous patents and applications, (U.S. Pat. Nos. 6,333,016, 6,413,487, U.S. Published Application 2002/0165091 and U.S. Published Application 2003/0091496, each of which is hereby expressly incorporated by reference herein in its entirety) we established that other elements of the Group VIb (Cr and W) exhibit similar behavior as Mo in stabilizing Co and generating selective catalysts for SWNT synthesis. It is the objective of the present work to identify other metal catalysts effective in selectively producing single-walled carbon nanotubes.

### BRIEF DESCRIPTION OF THE DRAWINGS

FIG. 1 is a graph showing the Temperature Programmed Reduction (TPR) profiles of several types of metal/silica catalysts.

FIG. 2 is a graph showing the Raman spectrum of a SWNT product by a Co—Re catalyst.

FIG. 3 is a graph showing the Temperature Programmed Oxidation (TPO of spent Co—Re (1:4) catalyst at different reduction temperatures.

FIG. 4 is a graph showing Raman spectra obtained on carbon products formed on a Co—Re (1:4) catalyst for different pre-reduction pretreatments.

FIG. 5 is a graph showing variability in nanotube quality (1-d/g) at various reduction temperatures.

FIG. 6 is a graph showing TPO results of spent Co—Re (1:4) catalyst at different reaction temperatures.

FIG. 7 is a graph showing TPO results of spent Co—Re catalysts at different Co:Re ratios.

### DETAILED DESCRIPTION OF THE INVENTION

The present invention is directed to catalysts comprising rhenium (Re) and at least one Group VIII metal such as Co, Ni, Ru, Rh, Pd, Ir, Fe and/or Pt. The catalyst may further comprise a Group VIb metal such as Cr, W, or Mo, and/or a Group Vb metal, such as Nb. The Re and the Group VIII metal are preferably disposed on a support material, such as silica. These catalysts are then used to produce carbon nanotubes and preferably predominantly single-walled carbon nanotubes which can then be used in a variety of different applications as described in more detail below.

A synergism exists between the at least two metal components of the bimetallic catalyst contemplated herein in that catalytic particles or substrates containing the catalyst are much more effective catalysts for the production of single-walled carbon nanotubes than catalytic particles containing either a Group VIII metal or Re alone.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples, which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

Experimental

A series of bimetallic Co—Re catalysts comprising a silica support was prepared by incipient wetness impregnation. The bimetallic catalysts, prepared by co-impregnation of aqueous rhenium chloride and Co nitrate solutions, had Co:Re molar ratios of 2:1, 1:1, and 1:4. In this series, the amount of Co was kept constant for all catalysts at 1.3 wt. %, while the amount of Re was varied accordingly. The SiO₂ support was a silica gel from Aldrich, 70-230 mesh, average pore size 6 nm, BET area 480 m²/g, pore volume 0.75 cm³/g. Other types of silica or other supports as discussed below may be used. Five grams of SiO₂ support were impregnated using a liquid-to-solid ratio of 0.6 cm³/g. After impregnation, the solids were dried overnight at 120° C. and then calcined in a horizontal fixed bed reactor for 3 h at 500° C. in dry-air flow of 50 scc/min. The solids may be dried and/or calcined under different conditions.

Temperature programmed reduction (TPR) experiments were conducted by passing a continuous flow of 5% H₂/Ar over approximately 30 mg of the calcined catalyst at a flow rate of 10 cm³/min, while linearly increasing the temperature at a heating rate of 8° C./min. The hydrogen uptake as a function of temperature was monitored using a thermal conductivity detector, SRI model 110 TCD. The TCD was calibrated for hydrogen consumption using TPR profiles of known amounts of CuO and relating the peak area to hydrogen uptake.

The Raman spectra of the nanotube product were obtained in a lovin Yvon-Horiba LabRam 800 equipped with a CCD detector and with three different laser excitation sources having wavelengths of 632 (He—Ne laser) 514 and 488 nm (Ar laser). Typical laser powers ranged from 3.0 to 5.0 mW; integration times were around 15 sec for each spectrum; three Raman spectra were averaged for each sample.

To study the effect of reaction parameters in the Co—Re system, the production of SWNT by CO disproportionation was conducted on a catalyst with a Co:Re molar ratio of 1:4 under different conditions. For the SWNT production on the Co—Re/SiO₂ catalysts, 0.5 g of a calcined sample was placed in a horizontal tubular packed-bed reactor; the reactor was 12 inches long and had a diameter of 0.5 inches. After loading the catalyst, the reactor was heated in 100 scc/min H₂ flow to different temperatures in the range 600° C.-900° C. at 10° C./min. Then, under 100 scc/min flow of He, it was heated up at the same rate to the specified reaction temperature, which ranged from 750° C. to 950° C. Subsequently, Co was introduced at a flow rate of 850 cm³/min at 84 psia for 2 hours. At the end of each run, the system was cooled down under He flow. The total amount of deposited carbon was determined by temperature-programmed oxidation (TPO) following the method described elsewhere. Other carbon-containing gases or fluids can be used in substitute of CO, as indicated in U.S. Pat. No. 6,333,016 and elsewhere herein.

Results

Characterization of the Catalysts

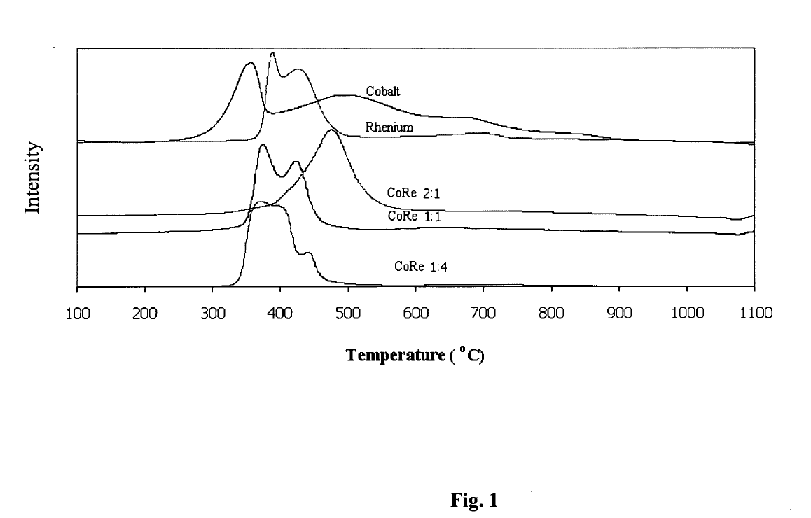

Temperature Programmed Reduction (TPR): The reduction profiles of calcined monometallic Co/SiO₂ and Re/SiO₂ catalysts together with those of bimetallic Co:Re/SiO₂ catalysts with Co:Re molar ratios=(2:1), (1:1), and (1:4) are shown in FIG. 1. The TPR profile of the Co monometallic catalyst shows two peaks at 340° C. and 500° C., which can be ascribed to the reduction of Co oxide species.

The reduction of the monometallic Re catalysts also exhibits two peaks at 390° C. and 420° C. Only the monometallic Co catalyst starts its reduction below 300° C. The disappearance of this low temperature Co reduction peak in the bimetallic catalysts is an indication of the Co—Re interaction.

Production of Single-Walled Carbon Nanotubes

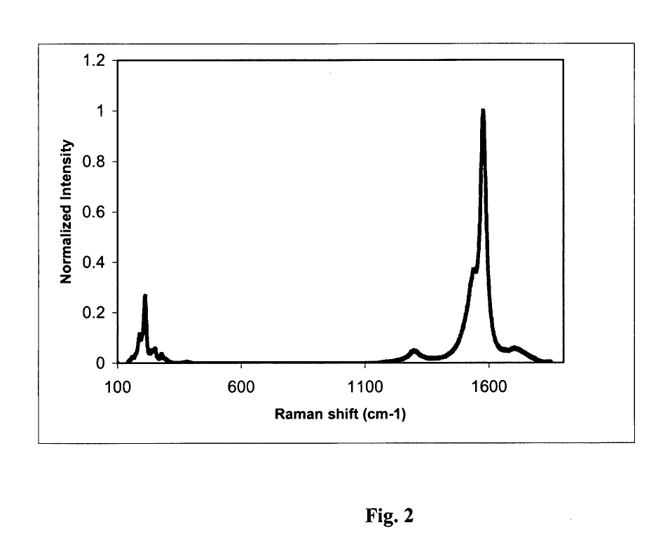

The Co—Re catalyst gives a nanotube product of high selectivity toward SWNT. The Raman spectrum of the carbon nanotube product (FIG. 2) indicates the presence of SWNT (breathing mode bands) and a low degree of disorder (low D/G ratio).

We have reported in previous articles that the silica-supported Co—Mo system displays a very high selectivity in the production of single wall nanotubes by Co disproportionation. When the Co:Mo(1:3)/SiO₂ catalyst which had exhibited a high yield and selectivity toward SWNT was employed without a reduction step or with an exceedingly high reduction temperature, poor SWNT yields were attained.

Herein, we investigated a Co—Re (1:4)/SiO₂ catalyst for SWNT production after different pre-reduction treatments. The reaction temperature for the CO disproportionation after a pre-reduction step was also varied from 750° C. up to 950° C. At the end of a two hour reaction period, the spent catalyst containing the carbon deposits was cooled down in He flow. The characterization of the carbon deposits was done by way of three techniques, including temperature programmed oxidation (TPO), transmission electron microscopy (TEM), and Raman spectroscopy.

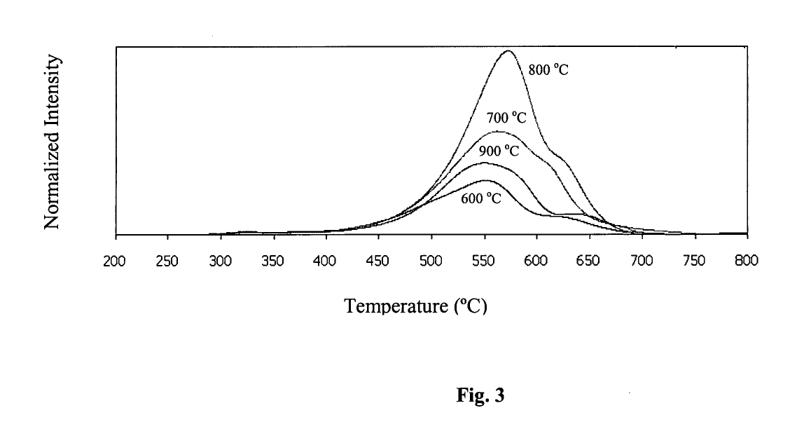

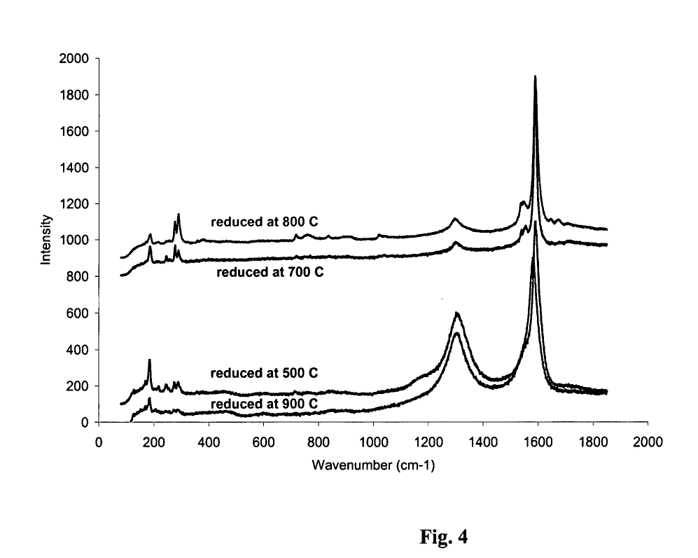

We have shown that from the TPO analysis one can obtain a quantitative measure of the carbon yield and selectivity towards SWNT. The TPO results obtained in the present work are summarized in FIGS. 3-4 and illustrate the strong influence of the reaction temperature and catalyst pretreatment on SWNT yield and selectivity.

Effect of Pre-Reduction Temperatures:

The effect of pre-reduction temperature was studied on the Co—Re (1:4) catalyst at a constant synthesis reaction temperature of 850° C. The TPO of the SWNT products obtained at 850° C. after different pre-reduction treatments is shown in FIG. 3.

It is seen that all the TPO profiles contain two peaks including one at around 560° C. and one at around 630° C. We have previously shown that the intensity ratio of the two TPO peaks (560° C./630° C.) is a rough indication of the selectivity since the first peak is associated with the oxidation of SWNT, while the second one is due to the oxidation of undesired carbon forms (defective multi-walled nanotubes and nanofibers). Accordingly, the higher reduction temperatures seem to enhance selectivity. At the same time, the carbon yield, which can be predicted from the overall peak intensity, has a maximum after reduction at about 800° C.

In addition to TPO, Raman spectroscopy (FIG. 4) provides valuable information about the structure of carbon nanotubes. The analysis of radial A1g breathing mode (below 300 cm⁻¹) gives direct information about the tubes diameter, while the analysis of the G band (related to ordered carbon including nanotubes and ordered graphite) in the tangential mode range i.e., 1400-1700 cm⁻¹, provides information on the electronic properties of the nanotubes. In addition, the analysis of the so-called D-band at around 1350 cm⁻¹ gives an indication of the level of disordered carbon (amorphous carbon and carbon fibers for example). The size of the D band relative to the G band at around 1590 cm⁻¹ has been used as qualitative measurement of the formation of undesirable forms of carbon.

FIG. 4 shows the Raman spectra obtained on the carbon deposits formed on the Co Re(1:4)/SiO₂ catalyst for different pre-reduction pretreatments, the pretreatments at 700° C. and 800° C. resulted in spectra that give evidence of SWNT of high quality. In both cases, the size of the D band relative to the G band was very small. In good agreement, the TPO indicated high selectivity to SWNT.

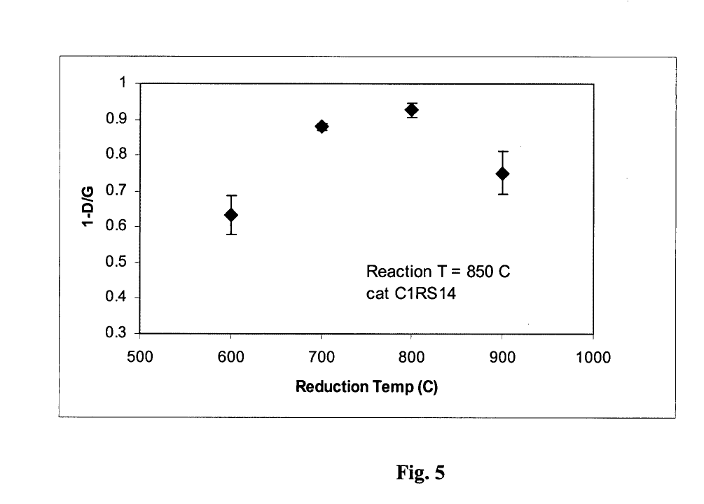

To quantify the effect of reduction temperature on the quality of nanotubes, we have defined a “quality parameter” in terms of the relative intensity of the D and G bands. The higher is this parameter (1−D/G), the better the quality of the SWNT (i.e., the higher the percentage of single-walled carbon nanotubes). As shown in FIG. 5, the pre-reduction temperature has an important effect on SWNT quality, which exhibits a maximum with a pre-reduction temperature of about 800° C. Preferably the pre-reduction temperature is in a range of from 650° C. to 850° C.

It is also observed in FIG. 5 that the variability of quality (as indicated by the error bars) is much greater after pretreatment at both, lower and higher temperatures than the optimum.

It is important to note that the Co—Re catalysts perform best under conditions in which Co and Re both are in the reduced metallic state before the catalyst is exposed to nanotube-forming conditions. This is significantly different from use of a Co—Mo catalyst, which must be in the non-reduced state before the nanotube forming reaction.

Effects of Reaction Temperature

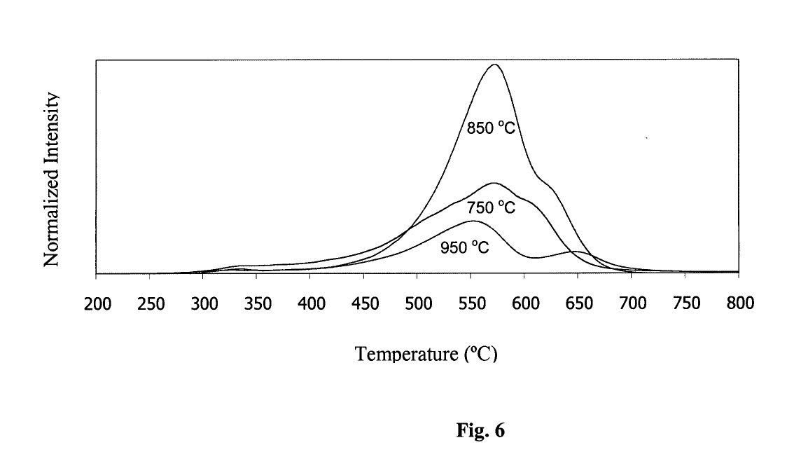

Pre-reduction in hydrogen at 800° C. was used as a constant pre-treatment to compare the effect of synthesis reaction temperature on the SWNT yield and selectivity. The CO disproportionation reaction conditions were: temperature: 850° C., CO flow rate: 850 sccm; total pressure of 85 psi pure CO; reaction time: 1 hr. The TPO of the product shown in FIG. 6 demonstrates that the reaction at 800° C. resulted in the highest SWNT yield and highest SWNT selectivity. Preferably the reaction temperature is in a range of from 650° C. to 950° C., and more preferably from 750° C. to 900° C., and more preferably from 825° C. to 875° C.

The Raman spectra are in good agreement with the TPO data. That is, in a preferred embodiment, pre-reduction occurs at 800° C. and the reaction occurs at 850° C.

Effect of Co:Re Ratio in the Catalyst

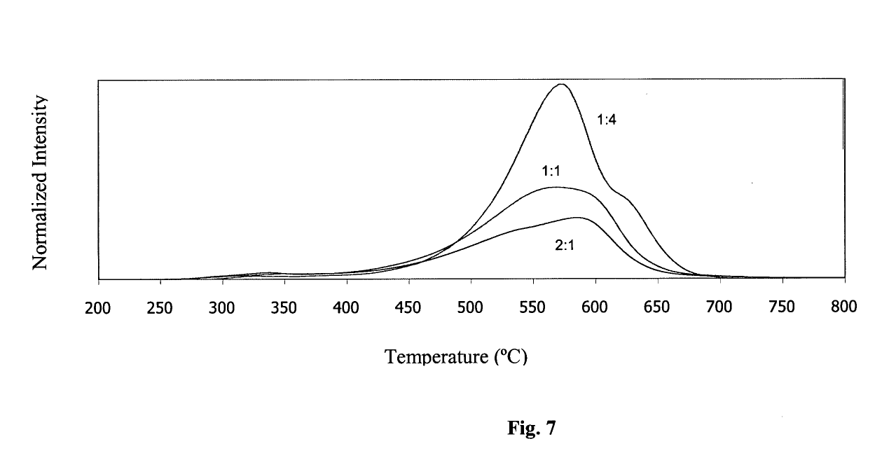

The yield and selectivity of the different Co:Re catalysts were compared after pre-reduction in hydrogen at 800° C. and CO disproportionation reaction at 850° C. under 850 sccm of CO at total pressure of 85 psi for 1 hr. The TPO of the carbon product obtained on the different catalysts are compared in FIG. 7. The catalyst having the lowest Co:Re ratio (1:4) exhibited the highest SWNT yield. Further, although those catalysts with lower Re content had low yields, they still had high SWNT selectivity.

A Re-only sample (without Co) was tested under the same conditions as the Co—Re sample. On this 2% Re/SiO₂ catalyst, both the carbon yield and nanotube selectivity were low indicating the necessity of the presence of Co in the catalyst composition.

Preferred operating conditions are a high reactive gas concentration, a temperature in the range of about 650° C.-850° C., high pressure (above about 70 psi), and a high space velocity (above about 30,000 h⁻¹) to maintain a low CO₂/reactive gas ratio during the process.

Where used herein, the phrase “an effective amount of a carbon-containing gas” means a gaseous carbon species (which may have been liquid before heating the reaction temperature) present in sufficient amounts to result in deposition of carbon on the catalytic particles at elevated temperatures, such as those described herein, resulting in formation of carbon nanotubes.

As noted elsewhere herein, the catalytic particles as described herein include a catalyst preferably deposited upon a support material. The catalyst as provided and employed in the present invention is preferably bimetallic and in an especially preferred version comprises Co and Re but in an alternative embodiment comprises at least one metal from Group VIII including Co, Ni, Ru, Rh, Pd, Ir, Fe and/or Pt, with the Re (from Group VIIb). For example, the catalyst may comprise Co—Re, Ni—Re, Ru—Re, Rh—Re, Ir—Re, Pd—Re, Fe—Re or Pt—Re. The catalyst may also comprise a metal from Group VIb including Cr, W, and Mo, and/or a metal from Group Vb including Nb. The catalyst may comprise more than one of the metals from any or all of the groups listed above.

Where used herein, the terms “catalyst” or “catalytic substrate” refer to a catalytic material comprising catalytic metals alone, or to catalytic metals deposited on a particulate or non-particulate substrate. The term “catalytic particle” refers to a catalyst comprising metals alone and having a particulate structure, orto catalytic metals deposited on a particulate substrate.

The ratio of the Group VIII metal to the Re in the catalytic particles may affect the yield, and/or the selective production of single-walled carbon nanotubes as noted elsewhere herein. The molar ratio of the Co (or other Group VIII metal) to the Re metal in a bimetallic catalyst is preferably from about 1:20 to about 20:1; more preferably about 1:10 to about 10:1; still more preferably from 1:8 to about 1:1; and most preferably about 1:4 to about 1:3 to about 1:2. Generally, the concentration of the Re metal exceeds the concentration of the Group VIII metal (e.g., Co) in catalysts employed for the selective production of single-walled carbon nanotubes.

The catalyst particles may be prepared by simply impregnating the support material with the solutions containing the Re and transition metal precursors (e.g., described above). Other preparation methods of supported catalysts may include coprecipitation of the support material and the selected transition metals. The catalyst can also be formed in situ through gas-phase decomposition of a mixture of precursor compounds including, but not limited to bis (cyclopentadienyl) cobalt and bis (cyclopentadienyl) rhenium chloride.

The catalyst is preferably deposited on a support material such as silica (SiO₂), mesoporous silica such as the MCM-41 (Mobil Crystalline Material-41) and the SBA-15 or other molecular sieve materials, alumina (Al₂O₃), MgO, aluminum-stabilized magnesium oxide, ZrO₂, titania, zeolites (including Y, beta, KL and mordenite), other oxidic supports known in the art and other supports as described herein.

The metallic catalyst may be prepared by evaporating the metal mixtures over support materials such as flat substrates including but not limited to quartz, glass, silicon, and oxidized silicon surfaces in a manner well known to persons of ordinary skill in the art.

The total amount of metal deposited on the support material may vary widely, but is generally in an amount of from about 0.1% to about 50% of the total weight of the catalytic substrate, and more preferably from about 1% to about 10% by weight of the catalytic substrate.

In an alternative version of the invention, the bimetallic catalyst may not be deposited on a support material, in which case the metal components comprise substantially 100% of the catalyst.

Examples of suitable carbon-containing gases which may be used herein include aliphatic hydrocarbons, both saturated and unsaturated, such as methane, ethane, propane, butane, hexane, ethylene, and propylene; carbon monoxide; oxygenated hydrocarbons such as ketones, aldehydes, and alcohols including ethanol and methanol; aromatic hydrocarbons such as toluene, benzene and naphthalene; and mixtures of the above, for example carbon monoxide and methane. Use of acetylene promotes formation nanofibers and graphite, while CO and methane are preferred feed gases for formation of single-walled carbon nanotubes. The carbon-containing gas may optionally be mixed with a diluent gas such as helium, argon or hydrogen.

A high space velocity (preferably above about 30,000 h⁻¹) is preferred to minimize the concentration of CO₂, a by-product of the reaction in the reactor, which inhibits the conversion to nanotubes. A high CO (or other reactive gas as described herein) concentration is preferred to minimize the formation of amorphous carbon deposits, which occur at low CO (reactive gas) concentrations. Therefore, the preferred reaction for use with the Co—Re catalyst temperature is between about 700° C. and 900° C.; more preferably between about 800° C. and 875° C.; and most preferably around about 850° C.

As noted elsewhere herein, in a preferred embodiment of the invention, the catalyst is a catalytic substrate, comprising a catalytic metal which catalyzes formation of carbon nanotubes (such as a Group VIII metal) and rhenium which are disposed upon a support material, wherein the catalytic substrate is able to selectively catalyze the formation of single-walled carbon nanotubes under suitable reaction conditions. Preferably the Group VIII metal is Co, but may alternatively be Ni, Ru, Rh, Pd, Ir, Pt, Fe, and combinations thereof. The catalyst may further comprise a Group VIb metal and or a Group Vb metal.

In one embodiment, the invention comprises a process for producing carbon nanotubes, including the steps of, providing catalytic particles (or catalytic substrates) comprising a support material and bimetallic catalyst comprising Re and Group VIII metal, the catalyst effective in catalyzing the conversion of a carbon-containing gas primarily into single-walled carbon nanotubes, reducing the catalytic particles to form reduced catalytic particles, and catalytically forming carbon nanotubes by exposing the reduced catalytic particles to a carbon-containing gas for a duration of time at a reaction temperature sufficient to cause catalytic production of single-walled carbon nanotubes thereby forming a carbon nanotube product comprising reacted catalytic particles bearing the carbon nanotubes. Single-walled carbon nanotubes preferably comprise at least 50% of the total carbon nanotube component of the carbon nanotube product. More preferably single-walled carbon nanotubes comprise 60%, 65%, 70%, 75%, 80%, 85%, 90%, 95%, 97.5%, 98% or 99% of the carbon nanotubes of the carbon nanotube product.

The process may include one or more of the additional steps of treating the reacted catalytic particles to separate the support material from the catalyst, treating the catalyst to separate the single-walled carbon nanotubes from the catalyst, recovering and recombining the support material and the catalyst to form regenerated catalytic particles, feeding the regenerated catalytic particles into the reactor, recycling the carbon-containing gas removed from the reactor after the catalysis step and reusing the carbon-containing gas in the catalysis step, and/or removing amorphous carbon deposited on the reacted catalytic particles.

The step of reducing the catalytic particles or catalytic substrate may further comprise exposing the catalytic particles to a heated reducing gas under elevated pressure. The step of treating the reacted catalytic particles to separate the carbon nanotubes from the catalyst may further comprise treating the catalyst with acid or base to dissolve the catalyst thereby yielding the carbon nanotubes. The recovering and recombining step may be further defined as precipitating the support material and catalyst in separate processing steps then combining the support material and catalyst wherein the support material is impregnated with the catalyst. The process may further comprise calcining and pelletizing the support material before or after the support material is impregnated with the catalyst. The process may be a fixed bed process, a moving bed process, a continuous flow process, or a fluidized-bed type process.

The carbon-containing gas used in the process may comprise a gas selected form the group consisting of CO, CH₄, C₂H₄, C₂H₂, alcohols, or mixtures thereof. The support material may be selected from the group consisting of SiO₂ including precipitated silicas and silica gel, Al₂O₃, MgO, Zro₂, zeolites (including Y, beta KL, and mordenite), mesoporous silica materials such as the MCM-41 and the SBA-15, other molecular sieves, and aluminum-stabilized magnesium oxide.

The Group VIII metal in the catalyst is selected from the group consisting of Co, Ni, Ru, Rh, Pd, Ir, Fe, Pt, and mixtures thereof. The catalytic substrate may further comprise a Group VIb metal selected from the group consisting of Cr, Mo, W, and mixtures thereof and/or a Group Vb metal. In the step of catalytically forming carbon nanotubes, the carbon-containing gas is preferably exposed to the catalytic substrate at a space velocity exceeding about 30,000 h⁻¹.

The invention contemplates a composition of carbon nanotubes produced by the method comprising feeding catalytic particles into a reactor wherein the catalytic particles (or substrate) comprise a support material and a catalyst comprising Re and a Group VIII metal, the catalyst effective in catalyzing the conversion of a carbon-containing gas into carbon nanotubes, reducing the catalytic particles to form reduced catalytic particles and exposing the reduced catalytic particles to a carbon-containing gas for a duration of time at a reaction temperature sufficient to cause catalytic production of carbon nanotubes thereby forming reacted catalytic particles bearing the carbon nanotubes, wherein the carbon nanotubes are substantially single-walled carbon nanotubes.

In-Situ Generation of Co—Re Catalyst for Gas-Phase Production of SWNT:

While not wishing to be constrained by theory, it appears that when Co metal particles are larger than about 2 nm, the decomposition of a carbon-containing molecule with Co metal particles does not result in single-walled carbon nanotubes, but rather irregular nanofibers. When carbon starts accumulating on the surface of a large Co particle, dissolution into the bulk of the metal particle takes place. After the solubility limit is exceeded, carbon precipitates out of the metal particle in the form of graphite. By contrast, when the Co particle is small, carbon accumulates on the surface and when the phase separation takes place, the carbon precipitation occurs in the form of a single shell, yielding single-walled carbon nanotubes.

Therefore, it is preferred to keep the Co particles small during the nanotube synthesis process. In the case of Co—Mo catalysts, keeping the Co particle small is accomplished by starting with a highly dispersed oxidic Co—Mo compound such as cobalt molybdate. However, in the case of Co—Re catalysts, the metals are apparently in the metallic state before the reaction starts. Therefore, in order to keep the Co particles small during the formation of single-walled nanotubes, Co and Re need to be in intimate contact wherein Co can be stabilized over Re in a high state of dispersion.

Effective Co—Re catalysts can be used for making single-walled carbon nanotubes in different forms. For example, when the Co—Re catalyst is supported on a solid support such as silica, alumina, magnesia, or titania it must be taken into consideration that any metal-support interaction should not inhibit the Co—Re interaction. Alternatively, Co—Re catalysts can be used as unsupported catalysts in the gas phase by injecting the two precursors into a gas stream of a carbon-containing gas or material such as described above (e.g., CO, ethylene, methane). In such a process Co and Re can be incorporated in the gas phase by injection of metal precursors such as Co and Re carbonyls, or Co and Re organometallic compounds such as cobaltocene and rhenocene in a way that results in Co—Re bimetallic clusters with the surface enriched in Co. This preferred bimetallic structure can be obtained by sequential injection of the Re precursor first and the Co precursor later.

### Utility

In one embodiment, the present invention contemplates a carbon nanotube product comprising single-walled nanotubes deposited on the catalytic substrates contemplated herein, as produced by any of the processes contemplated herein.

The carbon nanotube-catalyst support compositions produced herein can be used, for example, as electron field emitters, fillers of polymers to modify mechanical and electrical properties of the polymers, fillers of coatings to modify mechanical and electrical properties of the coatings, fillers for ceramic materials, and/or components of fuel-cell electrodes. These utilities are described in further detail in U.S. Ser. No. 10/834,351 and U.S. Ser. No. 60/570,213 which are hereby expressly incorporated herein by reference in their entirety.

The dispersion of SWNT in polymer matrices can be maximized by “in-situ-polymerization”. The properties of the SWNT-polymer composites obtained by this technique are much better than those obtained on a physical mixture of the same polymer and the nanotubes. A method which can be used to incorporate and disperse SWNT in polymers is mini-emulsion polymerization, a well-established method for producing polymer particles with very narrow size distributions. This process has the advantage of requiring substantially less surfactant to stabilize the reacting hydrophobic droplets inside the aqueous medium than in conventional emulsion polymerization. It also eliminates the complicated kinetics of monomer transfer into micelles that takes place in the conventional emulsion polymerization. SWNT-filled polystyrene (SWNT-PS) and styrene-isoprene composites prepared by this method show distinctive physical features such as: uniform black coloration; high solubility in toluene as well as in tetrahydrofuran (THF); and semiconductor to ohmic electrical behavior.

In-situ-polymerization techniques can also be used to obtain good dispersions of nanotube/catalyst composites in different matrices. Moreover, these composites can be selectively tailored for in-situ-polymerization of specific polymers by adding an active agent to either the composite or the bare catalyst before the nanotubes are produced.

As an example, we have prepared a SWNT/Co—Re/SiO₂ composite which has been doped with chromium to make it active for in-situ-polymerization of ethylene. Any of the catalyst particles bearing SWNT as described herein can be used to form polymers by in-situ-polymerization. Methods of in-situ-polymerization and uses of polymer mixture thereby produces are shown in further detail in U.S. Ser. No. 10/464,041 which is hereby expressly incorporated herein by reference in its entirety.

Changes may be made in the construction and the operation of the various compositions, components, elements and assemblies described herein or in the steps or the sequence of steps of the methods described herein without departing from the scope of the invention as defined in the following claims.

### CITED REFERENCES

1. Yakobson, B. I.; Smalley, R. E. Amer. Scientist. 1997, 85, 324.
2. Kong, J. A.; Cassell, A. M.; Dai, H. Chem. Phys. Lett. 1998, 292 567.
3. Nikolaev, P.; Bronikowski, M. J.; Bradley R. K.; Rohmund, F.; Colbert, D. T.; Smith, K. A.; Smalley, R. E. Chem. Phys. Lett. 1999, 313, 91.
4. Dai. H. Surf Sci. 2002, 500, 218.
5. Kitiyanan, B.; Alvarez, W. E.; Harwell, J. H.; and Resasco, D. E. Chem. Phys. Lett. 2001, 317, 497.
6. Herrera, J. E.; Balzano, L.; Borgna, A.; Alvarez, W. E.; Resasco, D. E. J. Catal. 2001, 204, 129.
7. Rao, A. M.; Richter, E.; Bandow, S.; Chase, B.; Eklund, P. C.; Williams, K. A.; Fang, S.; Subbaswamy, K.; Menon, M.; Thess, A.; Smalley, R. E.; Dresselhaus, G.; Dresselhaus, M. S. Science 1997, 275, 187.
8. Rols, S.; Righi, A.; Alvarez, L.; Anglaret, E.; Almairac, R.; Journet, C.; Bernier, P.; Sauvajol, J. L.; Benito, A. M.; Maser, W. K.; Munoz, E.; Martinez, M. T.; de la Fuente, G. F.; Girard, A.; Ameline, J. C. Eur. Phys. J. B. 2000, 18, 201.
9. Bandow, S.; Asaka, S.; Saito, Y.; Rao, A. M.; Grigorian, L.; Richter, E.; Eklund, P. C. Phys. Rev. Lett. 1998, 80, 3779.
10. Barraza, H.; Pompeo, F.; O'Rear, E.; Resasco, D. E., Nano Letters 2, 2002, 797-802.
11. Grady, B. P.; Shanbaugh, R. L.; Resasco, D. E., Journal of Physical Chemistry B 106, 2002, 5852-5858.

What is claimed is:

1. A carbon nanotube product, comprising:
a catalytic substrate, comprising:
rhenium and at least one Group VIII metal disposed on a support material; and
a carbon product on the catalytic substrate, the carbon product primarily comprising carbon nanotubes.

2. The carbon nanotube product of claim 1 wherein the carbon nanotubes primarily comprise single-walled carbon nanotubes.

3. The carbon nanotube product of claim 1 wherein the catalytic substrate further comprises at least one Group VIb metal.

4. The carbon nanotube product of claim 1 wherein the catalytic substrate further comprises at least one Group Vb metal.

5. The carbon nanotube product of claim 1 wherein the Group VIII metal of the catalytic substrate is at least one of Co, Ni, Rh, Ru, Pd, Pt, Ir and Fe.

6. The carbon nanotube product of claim 1 wherein the Group VIII metal of the catalytic substrate is Co.

7. The carbon nanotube product of claim 1 wherein the Group VIII metal of the catalytic substrate is Ni.

8. The carbon nanotube product of claim 1 wherein the Group VIII metal of the catalytic substrate is Rh.

9. The carbon nanotube product of claim 1 wherein the Group VIII metal of the catalytic substrate is Ru.

10. The carbon nanotube product of claim 1 wherein the Group VIII metal of the catalytic substrate is Pd.

11. The carbon nanotube product of claim 1 wherein the Group VIII metal of the catalytic substrate is Pt.

12. The carbon nanotube product of claim 1 wherein the Group VIII metal of the catalytic substrate is Ir.

13. The carbon nanotube product of claim 1 wherein the Group VIII metal of the catalytic substrate is Fe.

14. The carbon nanotube product of claim 1 wherein the support material of the catalytic substrate is at least one of SiO₂, precipitated silicas, silica gels, mesoporous silica materials (including MCM-41, SBA-15, and molecular sieves), La-stabilized aluminas, aluminas, MgO, ZrO₂, aluminum-stabilized magnesium oxide, and zeolites (including Y, beta, mordenite, and KL).

15. The carbon nanotube product of claim 1 wherein at least 75% of the carbon nanotubes are single-walled carbon nanotubes.

16. The carbon nanotube product of claim 1 wherein at least 90% of the carbon nanotubes are single-walled carbon nanotubes.

17. The carbon nanotube product of claim 1 wherein at least 95% of the carbon nanotubes are single-walled carbon nanotubes.

18. The carbon nanotube product of claim 1 wherein at least 99% of the carbon nanotubes are single-walled carbon nanotubes.

19. A single-walled carbon nanotube obtained from the carbon nanotube product of claim 1.

20. A nanotube-polymer composite comprising a polymer and the carbon nanotube product of claim 1.

21. A ceramic composite material comprising the carbon nanotube product of claim 1 and a ceramic matrix.

22. A fuel cell electrode comprising the carbon nanotube product of claim 1, an electrocatalyst, and an ionomer.

23. A field emission material comprising the carbon nanotube product of claim 1 and a binder, and wherein the field emission material can be adheringly dispersed over an electrode surface.

24. A field emission device comprising the field emission material of claim 23.

25. A carbon nanotube product, comprising:
a catalytic substrate comprising:
Re and Co and a silica support material; and
a carbon product deposited on the catalytic substrate, the carbon product primarily comprising carbon nanotubes.

26. The carbon nanotube product of claim 25 wherein the carbon nanotubes primarily comprise single-walled carbon nanotubes.

27. The carbon nanotube product of claim 25 wherein the catalytic substrate further comprises at least one Group VIb metal.

28. The carbon nanotube product of claim 25 wherein the catalytic substrate further comprises at least one Group Vb metal.

29. The carbon nanotube product of claim 25 wherein the support material of the catalytic substrate is at least one of SiO₂, precipitated silicas, silica gels, mesoporous silica materials (including MCM-41, SBA-15, and molecular sieves), La-stabilized aluminas, aluminas, MgO, ZrO₂, aluminum-stabilized magnesium oxide, and zeolites (including Y, beta, mordenite, and KL).

30. The carbon nanotube product of claim 25 wherein at least 75% of the carbon nanotubes are single-walled carbon nanotubes.

31. The carbon nanotube product of claim 25 wherein at least 90% of the carbon nanotubes are single-walled carbon nanotubes.

32. The carbon nanotube product of claim 25 wherein at least 95% of the carbon nanotubes are single-walled carbon nanotubes.

33. The carbon nanotube product of claim 25 wherein at least 99% of the carbon nanotubes are single-walled carbon nanotubes.

34. A single-walled carbon nanotube obtained from the carbon nanotube product of claim 25.

35. A nanotube-polymer composite comprising a polymer and the carbon nanotube product of claim 25.

36. A ceramic composite material comprising the carbon nanotube product of claim 25 and a ceramic matrix.

37. A fuel cell electrode comprising the carbon nanotube product of claim 25, an electrocatalyst, and an ionomer.

38. A field emission material comprising the carbon nanotube product of claim 25 and a binder, and wherein the field emission material can be adheringly dispersed over an electrode surface.

39. A field emission device comprising the field emission material of claim 38.

40. A method for producing carbon nanotubes, comprising:
providing a catalytic substrate comprising rhenium and at least one Group VIII metal; and
contacting the catalytic substrate with a carbon-containing gas in a reactor at a temperature sufficient to catalytically produce carbon nanotubes such that the carbon nanotubes are primarily single-walled carbon nanotubes.

41. The method of claim 40 wherein the Group VIII metal is at least one of Co, Ni, Ru, Rh, Pd, Ir, Fe and Pt.

42. The method of claim 40 wherein the catalytic substrate further comprises a Group VIb metal.

43. The method of claim 40 wherein the catalytic substrate further comprises a Group Vb metal.

44. The method of claim 40 wherein the catalytic substrate comprises a support material upon which the rhenium and at least one Group VIII metal are disposed.

45. The method of claim 44 wherein the support material is at least one of SiO₂, precipitated silica, silica gel, MCM-41, SBA-15 and other molecular sieves or mesoporous silica materials, alumina, MgO, aluminum-stabilized magnesium oxide, ZrO₂ and zeolites including Y, beta, KL and mordenite.

46. The method of claim 40 wherein a ratio of the Group VIII metal to rhenium is from about 1:20 to about 20:1.

47. The method of claim 40 wherein a ratio of the Group VIII metal to rhenium is from about 1:1 to about 1:8.

48. The method of claim 40 wherein the catalytic substrate has a concentration of rhenium which exceeds a concentration of the Group VIII metal in the catalytic substrate.

49. The method of claim 40 wherein the catalytic substrate comprises from about 1% to about 20% by weight of metal.

50. The method of claim 40 wherein the carbon-containing gas is at least one of saturated and/or unsaturated aliphatic hydrocarbons including methane, ethane, propane, butane, hexane, ethylene, and propylene; carbon monoxide; oxygenated hydrocarbons including ketones, aldehydes, and alcohols including ethanol and methanol; and aromatic hydrocarbons including toluene, benzene and naphthalene.

51. The method of claim 50 wherein the carbon-containing gas further comprises a diluent gas.

52. The method of claim 40 wherein the temperature is sufficiently below a thermal decomposition temperature of said carbon-containing gas to avoid substantial formation of pyrolytic carbon.

53. The method of claim 40 wherein the temperature is in a range of from about 650° C. to about 950° C.

54. The method of claim 40 wherein the temperature is in a range of from about 700° C. to about 900° C.

55. The method of claim 40 wherein the temperature is in a range of from about 800° C. to about 875° C.

56. The method of claim 40 wherein the catalytically produced carbon nanotubes further comprise multi-walled carbon nanotubes.

57. The method of claim 40 wherein the Group VIII metal of the catalytic substrate is Co.

58. The method of claim 40 wherein the Group VIII metal of the catalytic substrate is Ni.

59. The method of claim 40 wherein the Group VIII metal of the catalytic substrate is Ru.

60. The method of claim 40 wherein the Group VIII metal of the catalytic substrate is Rh.

61. The method of claim 40 wherein the Group VIII metal of the catalytic substrate is Pd.

62. The method of claim 40 wherein the Group VIII metal of the catalytic substrate is Ir.

63. The method of claim 40 wherein the Group VIII metal of the catalytic substrate is Pt.

64. The method of claim 40 wherein the Group VIII metal of the catalytic substrate is Fe.

65. The method of claim 42 wherein the Group VIb metal of the catalytic substrate is Cr.

66. The method of claim 42 wherein the Group VIb metal of the catalytic substrate is Mo.

67. The method of claim 42 wherein the Group VIb metal of the catalytic substrate is W.

68. The method of claim 40 wherein the reactor in which the catalytic substrate is contacted with the carbon-containing gas is a fluidized bed reactor.

69. The method of claim 40 wherein the carbon-containing gas is fed into the reactor having the catalytic substrate disposed therein.

70. The method of claim 40 wherein the step of contacting the catalytic substrate with the carbon-containing gas occurs at a high space velocity above about 30,000/hour.

71. The method of claim 40 wherein single-walled nanotubes comprise at least about 60% of the catalytically produced carbon nanotubes.

72. The method of claim 40 wherein the single-walled carbon nanotubes comprise at least 90% of the catalytically produced carbon nanotubes.

73. The method of claim 40 wherein the single-walled carbon nanotubes comprise at least 95% of the catalytically produced carbon nanotubes.

74. The method of claim 40 wherein the single-walled carbon nanotubes comprise at least 99% of the catalytically produced carbon nanotubes.

75. A single-walled carbon nanotube produced by the method of claim 40.

76. A carbon nanotube product comprising the carbon nanotubes and catalytic substrate of the method of claim 40.
